(19) United States
(12) Patent Application Publication
(10) Pub. No.: US 2014/0143782 A1
(43) Pub. Date: May 22, 2014

(54) COMPUTERIZED INFRASTRUCTURE MANAGEMENT SYSTEM AND METHOD

(71) Applicant: Syntel, Inc., Troy, MI (US)

(72) Inventors: L. Shekar, Siruseri (IN); Manoj Madhavan, Siruseri (IN); Vikram Hoshing, Talawade (IN); Vikash Agarwal, Talawade (IN)

(21) Appl. No.: 14/083,719

(22) Filed: Nov. 19, 2013

Related U.S. Application Data
(60) Provisional application No. 61/727,821, filed on Nov. 19, 2012.

(51) Int. Cl. G06F 9/48

(52) U.S. Cl. CPC G06F 9/4806
USPC 718/100

(57) ABSTRACT

An automation framework that bridges the gaps between the complete manual work and complex maintenance hungry tools. This automation framework enables business-driven automated system administration capabilities and focuses on independent task management between business needs and system administrators in order to model automation in line with the requirements of IT operations. In some embodiments, this framework minimizes manual effort, delegates complex tasks to junior resources without exposing critical systems and incorporates governance.

### RELATED APPLICATIONS

The present application is related to and claims priority to U.S. Provisional Patent Application Ser. No. 61/727,821, filed on Nov. 19, 2012, entitled “Computerized Infrastructure Management System and Method.” The subject matter disclosed in that provisional application is hereby expressly incorporated into the present application.

### TECHNICAL FIELD

The present disclosure relates generally to computerized systems and methods; in particular, the disclosure relates to an automation framework that enables business-driven system administration capabilities.

### BACKGROUND AND SUMMARY

Infrastructure management Services has been commercialized over the last decade and has now been referred to as the second wave of IT. Factors both of technical significance and business mandate have made organizations demand commercialization of these services. The concept of run book automation for infrastructure management has emerged as a key enabler for improving critical service delivery operations and provides high cost benefit. The business outcome is improved customer satisfaction, increased operational efficiency and reduced total cost of ownership.

Traditionally, subject matter experts from respective technologies perform various system administration tasks manually, which at times are of large volume, highly repetitive and more than often prone to human error. Data security, system criticality and its business impact makes it difficult to delegate even routine administrative tasks to junior employees who bear limited data privileges.

The existing tools in the market provide solutions catering to specific technology resulting in excessive maintenance of multiple solutions for each technology domain. This reaches a point wherein managing the tools itself becomes an overhead, defeating the entire purpose and goals of managing the underlying IT infrastructure both in terms of resources and business cost. Ideally, a tool required for such automation must have minimum dependency on manual intervention.

According to one aspect, the present invention provides an automation framework that bridges the gaps between the complete manual work and complex maintenance hungry tools. This automation framework enables business-driven automated system administration capabilities and focuses on independent task management between business needs and system administrators in order to model automation in line with the requirements of IT operations.

In some embodiments, this framework minimizes manual effort, delegates complex tasks to junior resources without exposing critical systems and incorporates governance. This platform ensures a unified administration console independent of target technology domains and devices.

Additional features and advantages of the invention will become apparent to those skilled in the art upon consideration of the following detailed description of the illustrated embodiment exemplifying the best mode of carrying out the invention as presently perceived.

### BRIEF DESCRIPTION OF DRAWINGS

The present disclosure will be described hereafter with reference to the attached drawings which are given as non-limiting examples only, in which:

FIG. 1 is an overall process flow for performing operations on different technologies according to one embodiment.

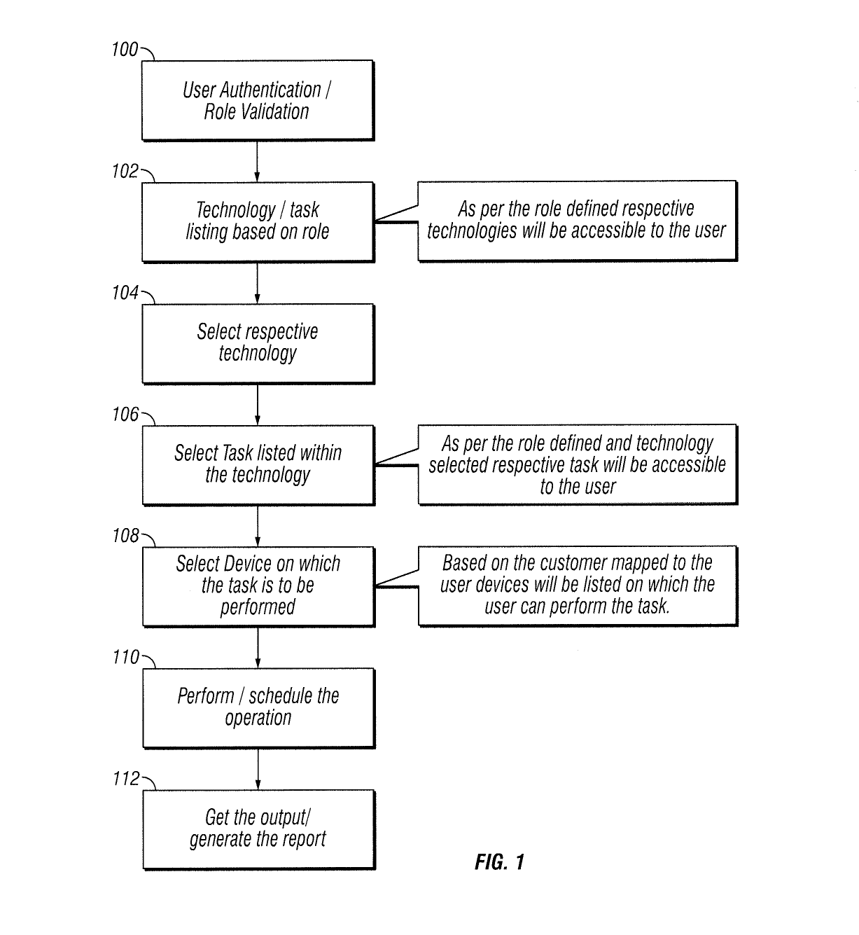

FIG. 2 is a diagram showing the overall architecture of the platform according to one embodiment.

FIG. 3 is an example screen shot showing an example interview from which a report could be exported according to one embodiment.

FIG. 4 is an example screen show showing an example interface from which various tasks could be scheduled according to one embodiment.

FIG. 5 is a diagram showing an example architecture of an operating system module according to one embodiment.

FIG. 6 is a diagram showing an example architecture of a database module according to one embodiment.

FIG. 7 is a diagram showing an example architecture of a messaging module according to one embodiment.

FIG. 8 is a diagram showing an example architecture of a middleware module according to one embodiment.

Corresponding reference characters indicate corresponding parts throughout the several views. The exemplification set out herein illustrates embodiments of the invention, and such exemplification is not to be construed as limiting the scope of the invention in any manner.

### DETAILED DESCRIPTION OF THE DRAWINGS

As any IT system administrator will confirm, there is surplus of redundancy and repetition in the day-to-day operations—manually administering, managing, and maintaining the state of the complex enterprise IT infrastructure. Most of these tasks adversely impact the operational efficiency, resolution timeframes, personnel response times, and so forth of the organization. This turns particularly complex where a diverse set of heterogeneous systems and hardware platforms (e.g., AIX, HP-UX, Linux, Solaris, Windows, Databases, Messaging, Middleware, etc.) often work alongside one another, each with its own operational peculiarities, management needs, limitations and technical knowhow.

The common practice has been towards using scripts to automate the tasks. However, the issue with scripted automation in the enterprise environment is the simple fact that scripts lacks agility and flexibility, and thereby hinders business process flow. When pre-packaged scripts are readily available along with a suitable management tool or framework, they tend to be generic in nature. This explains why such scripts are not generally usable outside their intended (and narrow) applications, or suitable for adaptation for other environments or purposes. Moreover, any enhancement or customization as per business need would again require development and coding skill set.

According to one aspect, the present framework helps minimize the operational cost and burden of manually administering, managing and maintaining the Enterprise IT infrastructure by encapsulating a diverse set of technology in a single platform. It empowers engineers with tribal knowledge by making the system explicit, readily accessible and intuitive to perform complex administrative task (deskilling).

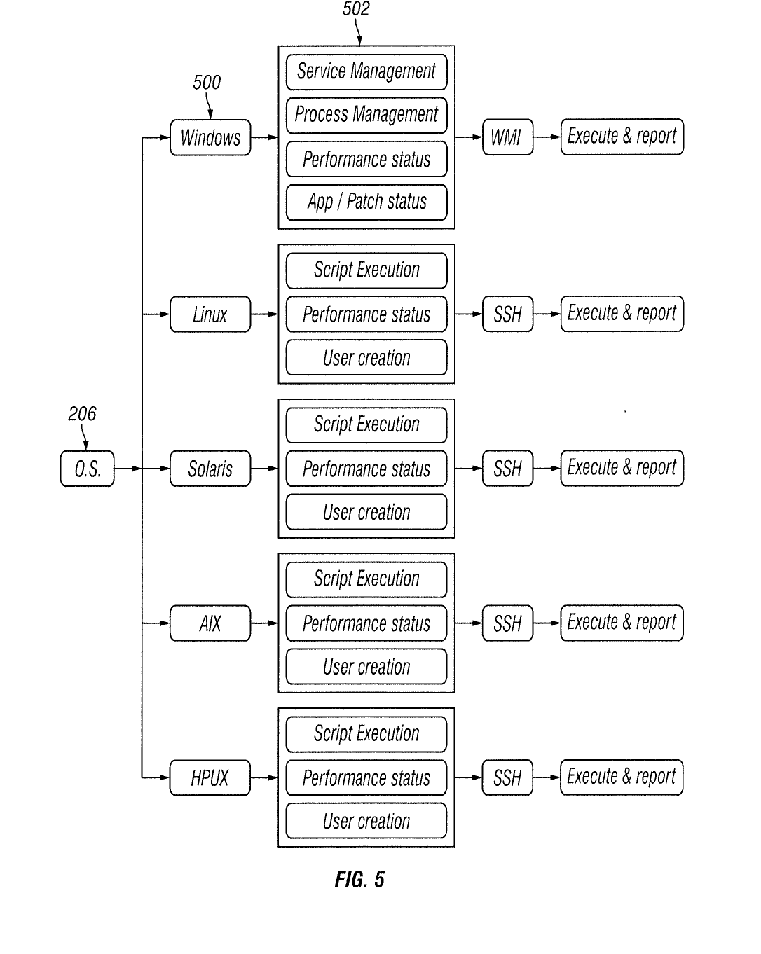

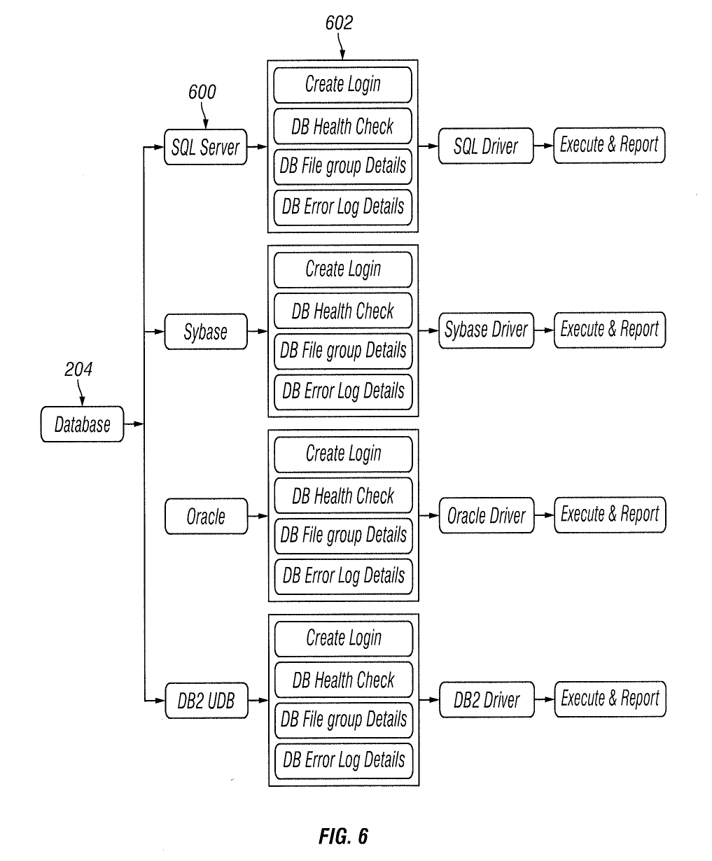

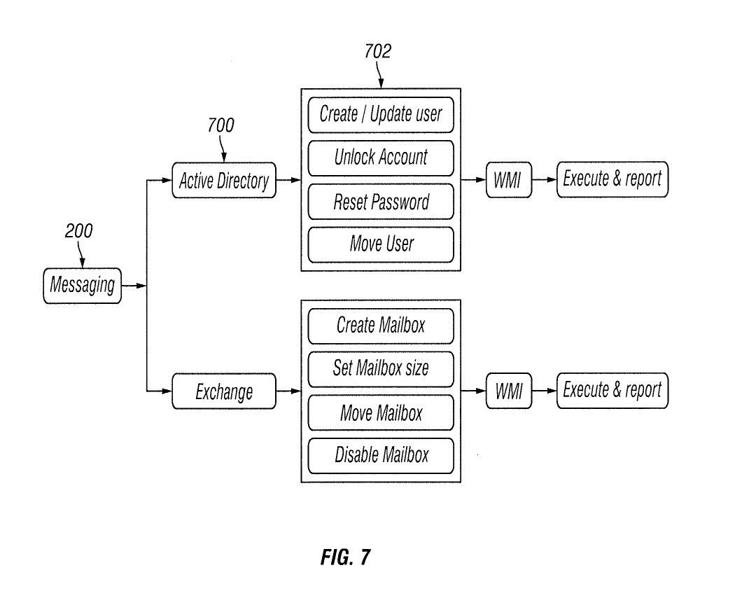

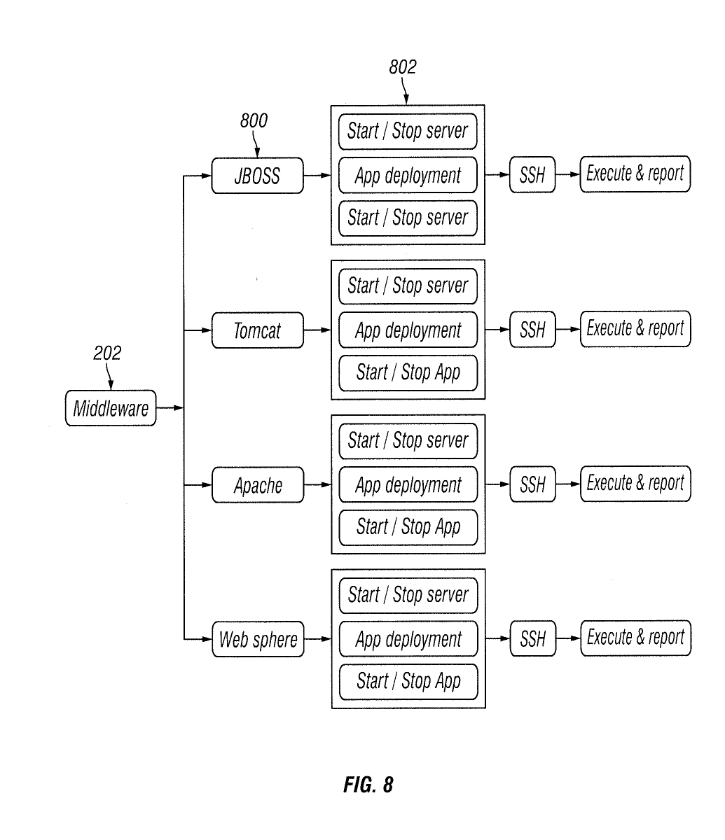

The platform encapsulates underlying technologies across vendors and provides the system administrator with a simple yet powerful, unified console to perform multiple day to day operations, such as with just one a click of a button. According to one embodiment, the platform includes the following non-exhaustive list of modules:
Operating system module (e.g., Windows, Linux, Solaris, Aix, HPUX) (refer to FIG. 5)
Database module—(e.g., SQL server, Oracle, DB2 UDB, Sybase) (refer to FIG. 6)
Messaging module (e.g., Active directory, Exchange) (refer to FIG. 7)
Middleware module (e.g., JBOSS, Tomcat, Apache, Web sphere) (refer to FIG. 8)
   This automation platform eliminates the need to spend non value added time and effort to remotely connect, login to multiple systems and perform desired operation.

In one embodiment, the platform provides user validation and/or role selection. For example, this validation could be provided with a username and password, biometric validation or other validation system (block 100). The system determines the role and access of the user to particular technologies based on the validation process. For example, the technologies available to the user could be determined by the role associated with the user, which could be presented to the user in the form of a list. (block 102). The user can then select from the list of technologies (block 104). Depending on the technology selected by the user, a list of tasks that could be performed for the selected technology could be selected by the user (block 106). Based on the task selected by the user, a device on which the task is to be performed can be selected (block 108). This task can be performed by the system or scheduled at a later time (block 110). The output from performing the task can be captured and a report can be generated by the system (block 112). The operating system automation can be performed through the creation of user profile on multiple systems of selected O.S. technology. This substantially reduces human effort and errors by creation of multiple users on multiple systems at a click.

This automation platform has an inbuilt robust job scheduler which allows scheduling of existing Windows and UNIX modules across multiple systems on the network (e.g. block 110).

In some embodiments, the platform maintains track of each and every operation performed by the administrator and associated attributes. It is capable of generating a report based on various permutations and combinations (block 112).

The platform has an in-built log processing engine. This engine has the capability to analyze standard application logs at run time and also flag known errors based on administrator provided parameters.

The validation rules in relevant modules as per predefined algorithms, prevent any rule violation and enforce process adherence.

High level of security is ensured by authenticating/authorizing the user on the target platform before performing any operation. An example of this could be a user without having update permission in active directory cannot initiate update request even though permission is provided at application level.

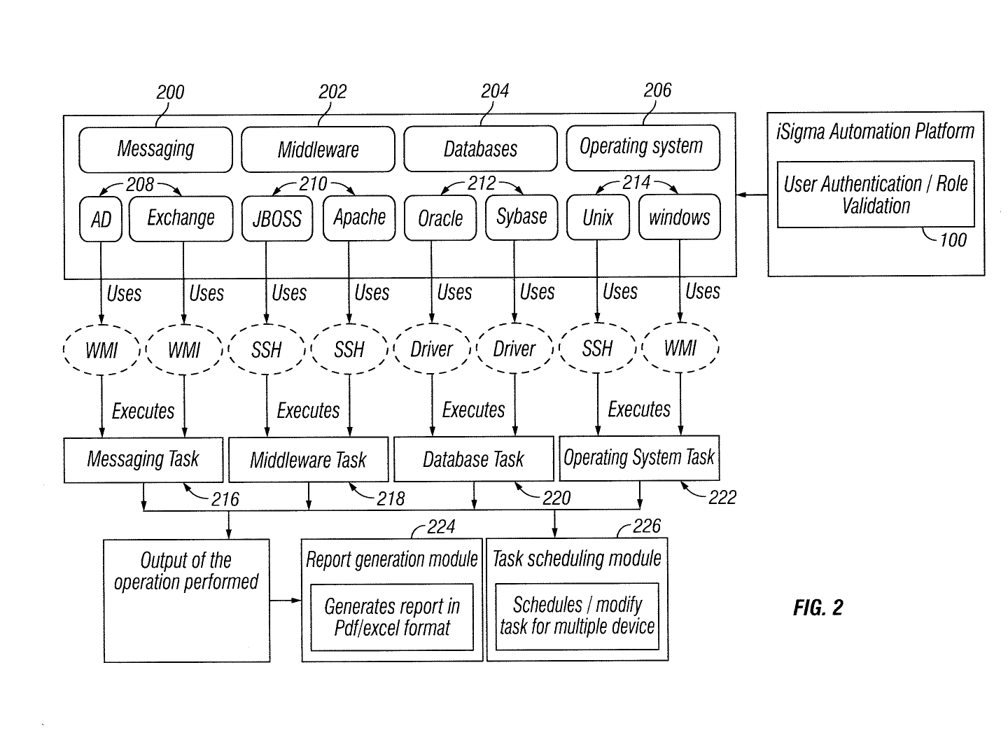

FIG. 2 shows an example architecture diagram of the platform according to one embodiment. In the example shown, the platform requires validation for the user to access to platform. This also establishes the role of the user, which sets the technology modules to which the user has access. In this example, the platform includes a messaging module 200, a middleware module 202, a databases module 204 and an operating system module 206. In the example shown, the messaging module 200 is configured to perform tasks 216 relating to either active directory or exchange 208. As shown, the middleware module 202 is shown in this example to be configured to perform tasks 218 concerning JBoss and Apache 210. The databases module 204, in this example, is configured to perform one or more tasks 220 concerning Oracle and Sybase 202. The operating system module 206, in the example shown, is configured to perform one or more tasks 222 concerning SSH and WMI in this example.

In the embodiment shown, the platform includes a reporting module 224 and a scheduling module 226. The reporting module 224 is configured to generate reports concerning the tasks performed in a plurality of formats, such as a PDF and/or a spreadsheet. The scheduling module 226 allows one or more tasks to be scheduled (or the existing schedule to be modified). The tasks could be scheduled to be performed on one or more devices.

System administrators need to connect to multiple devices sequentially and execute commands for housekeeping. Plug-ins of the platform enable the same via Windows and SSH connector, which establish connections automatically in the background and execute desired commands.

In some embodiments, the platform is developed in .Net framework 4.0 using C# and ASP.net. The platform could be deployed on windows 2008 server with IIS 7 as web server. Microsoft SQL server 2008 database acts as primary data store.

Task automation modules of the platform have been developed for different technologies using appropriate and standard methodologies which are covered in points below. In some embodiments, Active Directory/Exchange modules use directory services class and power shell cmdlets. In some embodiments, database modules for Sybase use ASEOLEDB driver, Oracle use ODBC driver and MS SQL server use ADO.net driver for database operations.

The platform has in-built report generation framework 224 which enables generation of reports, such as in excel and Pdf format at runtime.

Key reports which can be generated from various technology modules include, but are not limited to:-
Service information report
Process information report
Installed patch report
Installed application report
Database health check report
Database error log report
Database/tables size report
Active users report
Mailbox report etc.

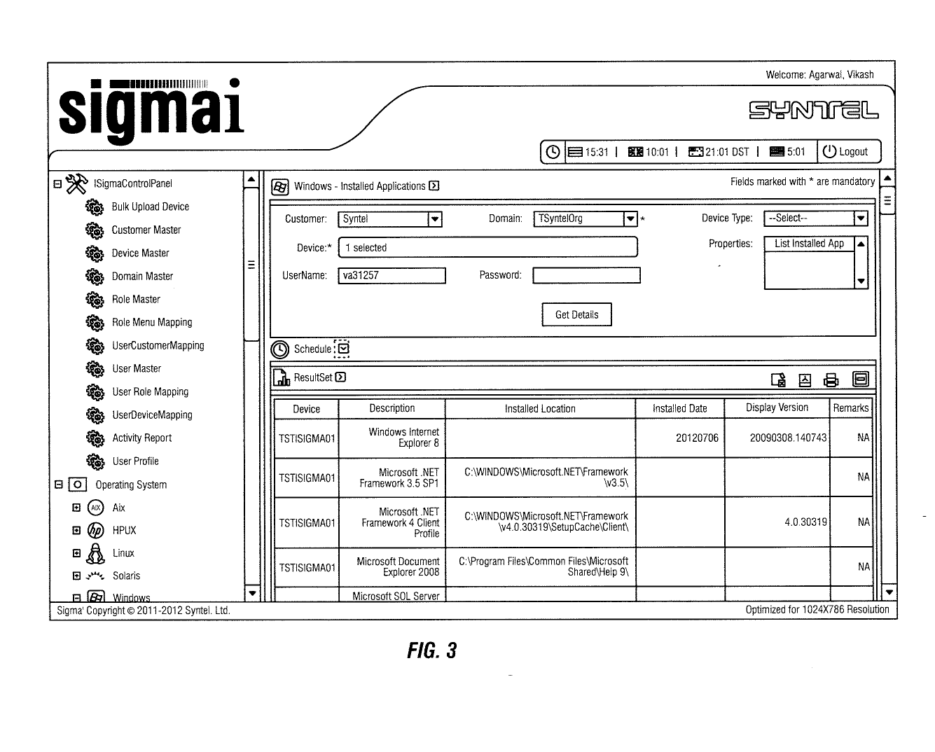

The report can be generated after each technology task. The output can be exported to the desired format. In some embodiments, the application uses the .Net library to generate the report. FIG. 3 shows an example interface from which a report could be exported by selecting a button for different report formats as desired.

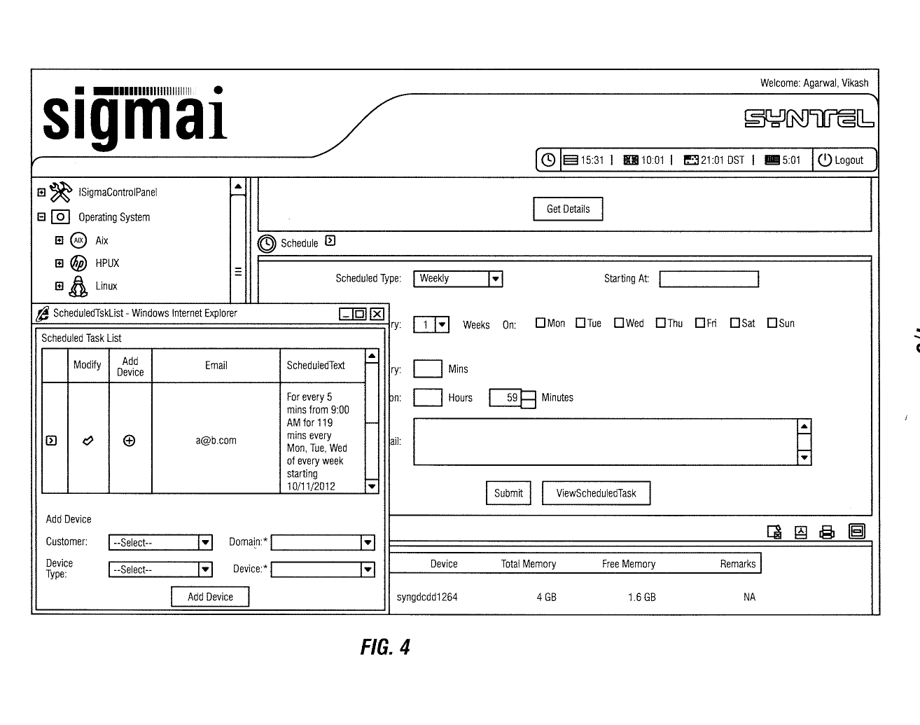

In some embodiments, the platform is bundled with task scheduling framework 226. This provides an easy to use interface to the administrator to schedule available tasks. In some embodiments, the task scheduling framework is implemented in modular fashion and plugs-in seamlessly with the platform. The task scheduler enables system administrators to schedule a particular technology task for multiple devices at a time. The task scheduler provides an interface which gives visibility in terms of tasks which have been scheduled and can be re-configured. FIG. 4 shows an example interface for the task scheduling module 226.

FIG. 5 shows an example operating system module 206 according to one embodiment. The operating system modules automate various task across operating system technologies 500, such as Windows, Redhat Linux, HP UX, IBM AIX etc. and enables the administrator to view various performance parameters 502, such as service status, process status, etc. for multiple devices via appropriate O.S. connectors.

FIG. 6 shows an example database module 204 that communicates with most widely used enterprise RDBMS 600, such as Oracle, MS SQL, Sybase, SQL DB2, etc. In contrast with other automation solutions, it does not require expert database administration skills. Database automation helps enterprise better manage their database operations, reducing downtimes as well as the overall time taken in database management. It enables the database administrator to perform a plurality of tasks 602, including but not limited to: view database health, disk details, error logs, locks in the database, tablespace details, failed job details, active process details for multiple database servers. It also enables the administrator to manage database operations such as user creation, assigning roles to user etc. as well as schedule various operations.

FIG. 7 shows an example messaging module 204 simplifies user provisioning, Active directory and exchange administration 700. It provides a single console from which an IT administrator can perform a variety of tasks 702, such as view and manage active directory users, computers, contacts, groups, mailboxes and reports on active directory and exchange environment thus avoiding manual, error prone administrative activities and saves cost and time respectively.

FIG. 8 shows an example middleware module 202. The platform works with any middleware technologies 800, such as Jboss, Tomcat, Web logic, Web Sphere, etc. It enables the administrator to perform a variety of tasks 802, such as easily manage the JVM servers, deploy enterprise java applications quickly and manage their configurations efficiently and safely. It eliminates error with consistent deployment across multiple environments. Reduce installation and configuration risk by eliminating manual processes.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

What is claimed is:

1. A computerized system comprising:
a validation module on a computer configured to determine a role of a user based on login credentials of the user; and
a platform configured to present one or more technologies for which the user can select responsive to the role of the user, wherein the platform is configured to present a plurality of tasks related to the technology for which the platform can execute on a device.

2. The computer system as recited in claim 1, wherein the platform includes an operating system module, wherein the operating system module is configured to perform one or more selectable actions to test the operating system.

3. The computer system as recited in claim 2, wherein the operating system module is configured to determine a plurality of performance parameters concerning an operating system.

4. The computer system as recited in claim 3, wherein the plurality of performance parameters includes one or more of a service status and process status.

5. The computer system as recited in claim 1, wherein the platform includes an database module, wherein the database module is configured to perform one or more selectable actions to determine performance parameters of a database.

6. The computer system as recited in claim 5, wherein the plurality of performance parameters includes one or more of a view of database health, disk details, error logs, locks in the database, tablespace details, failed job details, and active process details for multiple database servers.

7. The computer system as recited in claim 1, wherein the platform includes an messaging module, wherein the messaging module is configured to perform one or more selectable actions to manage messaging of users.

8. The computer system as recited in claim 7, wherein the management of messaging include includes one or more of a view of active directory users, computers, contacts, groups, mailboxes and reports on active directory.

9. The computer system as recited in claim 1, wherein the platform includes a middleware module, wherein the middleware module is configured to perform one or more selectable actions to manage middleware.

10. The computer system as recited in claim 9, wherein the management of messaging includes one or more managing JVM servers and deploy enterprise java applications.

11. The computer system as recited in claim 1, wherein the platform includes a reporting module.

12. The computer system as recited in claim 11, wherein the reporting module is configured to generate a report with one or more parameters relevant to the administrative tasks performed using the said system for a selected technology.

13. The computer system as recited in claim 12, wherein the reporting module is configured to generating one or more of the following reports: service information report, process information report, installed patch report, installed application report, database health check report, database error log report, database/tables size report, active users report and mailbox report.

14. The computer system as recited in claim 1, wherein the platform includes a scheduling module.

15. The computer system as recited in claim 14, wherein the scheduling module is configured to schedule one or more tasks selected by a user.
